(19) United States
(12) Patent Application Publication
(10) Pub. No.: US 2006/0216042 A1
(43) Pub. Date: Sep. 28, 2006

(54) Automatic gain control circuit for infrared receiver

(76) Inventors: Kok Soon Yeo, Singapore (SG); Lian Chun Xu, Singapore (SG); Chee Keong Teo, Singapore (SG); John Julius Asuncion, Singapore (SG); Wai Keat Tai, Singapore (SG)

Correspondence Address: AVAGO TECHNOLOGIES, LTD., P.O. BOX 1920, DENVER, CO, 80201-1920, US

(21) Appl. No.: 11/089,835

(22) Filed: Mar. 24, 2005

(51) Int. Cl. H04B 10/06

(52) U.S. Cl. 398/209

(57) ABSTRACT

An optical receiver includes a photodetector coupled to a gain section having a variable gain stage. The gain stage provides an output voltage signal. A digital automatic gain control circuit is coupled to the output voltage signal and provides a digital output value to at least the variable gain stage. The gain of the variable gain stage is set according to the digital output value.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

Optical transmission systems are used in a variety of applications. Some applications transmit data in an optical signal carried on an optical fiber. Other applications transmit an optical signal through free space to an optical receiver. Examples of such systems are defined in the Infrared Data Association (“IrDA”) communications standard. The IrDA communications standard is used when designing infrared (“IR”) data ports on electronic devices, such as computers, personal digital assistants, and mobile telephones.

IR data transmissions between devices using the IrDA communications standard transmit information at communication speeds typically between about 100 kbps and 16 Mbps. At the higher bit rate, more bandwidth is required to accommodate signal integrity. The IrDA specification supports optical communications links between two nodes (electronic devices) from about 0 meters to about 1 meter apart. In some instances, low power output from the transmitting device limits the inter-node spacing to less than 20 cm.

An IR receiver typically has a photodetector converting an optical data signal into an electrical data signal that is amplified by one or more gain stages. The electrical signal is provided to a comparator, which compares the electrical signal against a threshold voltage to determine whether an optical pulse was received. For example, when the amplitude of the electrical signal is greater than the threshold voltage, a pulse generator coupled to the comparator provides a received data output pulse. If any one of the gain stages saturates or has insufficient gain to maintain the data signal at the proper level(s) information can be lost.

If the amplitude of the electrical signal provided to the comparator is close to the threshold voltage, jitter can corrupt the received data output signal by making a data pulse (data one) appear as a data zero, for example. A similar problem arises at saturation, when a data zero condition exceeds the threshold voltage, or is close enough to the threshold voltage so that jitter can cause a data zero to appear as a data pulse (data one)

An IR receiver with high dynamic range is desirable to receive data transmitted from weak and/or distant IR transmitters, as well as from strong and/or near IR transmitters. Conventional IR receivers have gain-control circuits that maintain the data output at a desired level using analog automatic gain control (“AGC”). A negative feedback signal is provided to a variable gain amplifier in the receiver to obtain an electrical signal at a desired level (amplitude) that is coupled to the comparator. Without AGC, a strong signal strength amplified by the receiver's gain can become saturated. This can result in wide pulses or a distorted output waveform that may exceed the specifications of the decoder causing errors decoding.

Conventional analog AGCs typically use the average (i.e. direct current (“DC”)) component of the output as a measure of the input swing to generate an error voltage signal. A trans-impedance amplifier (“TIA”) senses input current that is generated from 20 the photo-detector and converted into a voltage signal. This voltage signal is passed through a low pass filter to generate the output time average voltage V_{out.avg}. A replica of the TIA establishes a reference voltage corresponding to zero input current. An output proportional to the error voltage, and hence input amplitude, is generated and fed back.

An issue when designing an analog AGC is the selection of the corner frequency of the low pass filter. If the corner frequency is too high, then low-frequency components in data waveform pass through the R₁-C₁ network unattenuated forcing the output voltage to change with time and ultimately corrupt the data. From another perspective, one can look the attack time for a receiver to settle and work within a required input range to have a good error rate when there is a change in the signal inputted from the photo detector. Attack time is the time taken for the error control voltage to settle to a certain voltage. The time is dependent on the RC product of the low-pass filter.

If the RC product is large, it will have a longer attack time and more errors bits occur initially before the receiver has adjusted the output voltage to within the required range. Shorter attack time means faster settling time, however it may create variations of control voltage between each bit, which can also cause errors.

Charging of the capacitor in the low pass filter depends on the signal strength, as does the settling/attack time. The setting of the RC value depends on data rates and the required settling/attack time. In IrDA communications, the speed can be from less than 100 kbps for SIR to 16 Mbps for VFIR. Thus, the value of the RC product in an analog AGC needs to be adjusted for various bit rates for optimum detection and settling/attack time. A variable link distance (typically from essentially 0 meters to about 1 meter) also affects the signal strength. For example, a relatively strong IR signal becomes weaker as the source is moved away from the receiver. Variable link distance also affects the required dynamic range of the amplification in the receiver.

Therefore, AGCs for IR receivers that avoid the problems of conventional AGCs used with IR receivers are desirable.

### BRIEF SUMMARY OF THE INVENTION

An optical receiver includes a photodetector coupled to a gain section having a variable gain stage. The gain stage provides an output voltage signal. A digital automatic gain control circuit is coupled to the output voltage signal and provides a digital output value to at least the variable gain stage. The gain of the variable gain stage is set according to the digital output value.

### BRIEF DESCRIPTION OF THE DRAWINGS

FIG. 1A shows an optical receiver with a digital AGC circuit according to an embodiment of the invention.

FIG. 1B shows a voltage reference circuit according to an embodiment of the invention.

FIG. 1C shows an integrated digital AGC circuit according to an embodiment of the invention.

FIG. 2 shows a portion of a digital optical receiver according to an embodiment of the invention.

FIG. 3 shows plots of input and output signals of a digital AGC according to an embodiment.

FIG. 4 is a state diagram according to an embodiment of the invention using a four-bit shift register as a counter.

### DETAILED DESCRIPTION OF THE EMBODIMENTS

A digital AGC avoids problems arising in analog AGCs. The settling/attack time of a digital AGC can be implemented digitally and can settle down within a few clock cycles. In a particular embodiment, the settling/attack time is a function of the data bits that generated the clock, but not the bit rate. If the design settles from the maximum gain to the minimum gain within four cycles from the maximum input, the receiver will settle down within four cycles for any input strength and data rate. Therefore, a digital AGC can achieve an efficient and rapid settling/attack time so that the output signal of the variable gain section is within the specified range and data transfer occurs quickly and with fewer errors.

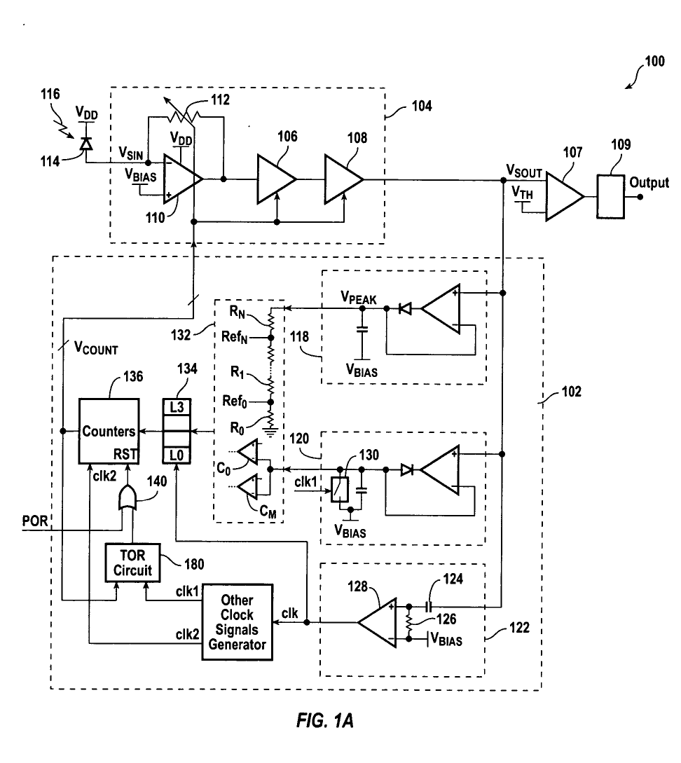

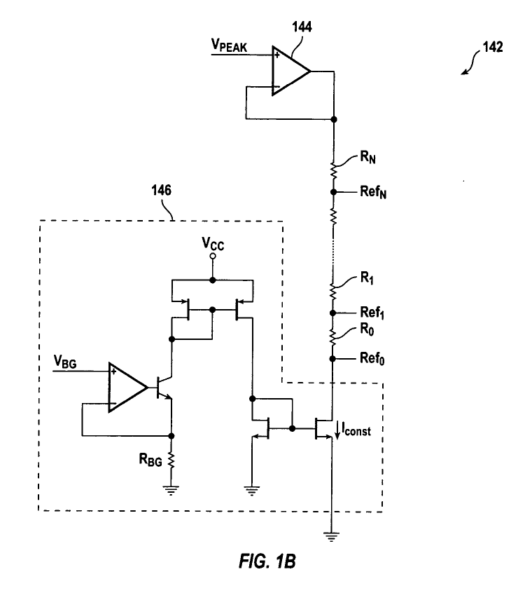

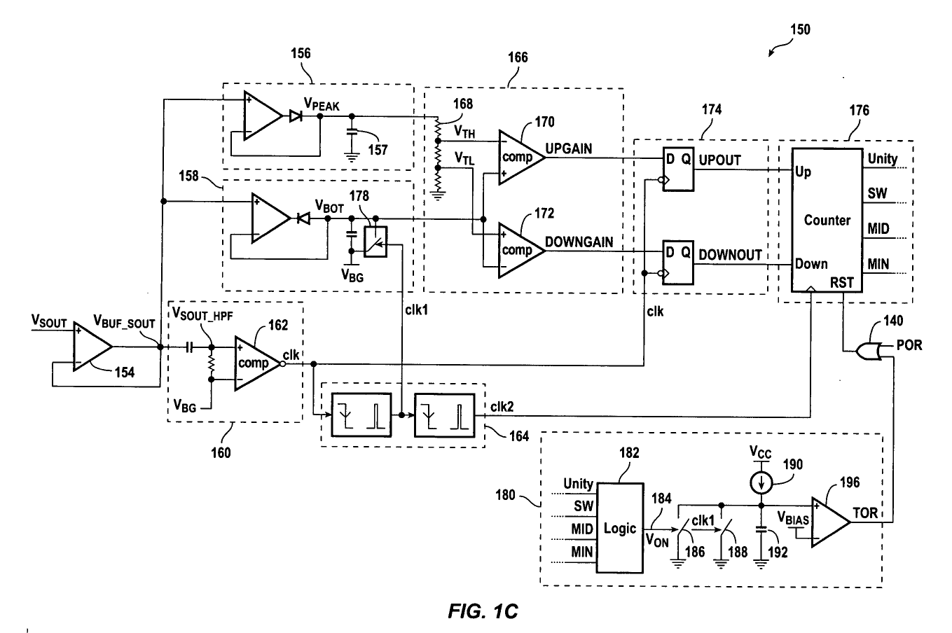

FIG. 1A shows an optical receiver 100 with a digital AGC circuit 102 according to an embodiment of the invention. The optical receiver 100 includes a gain section 104 having two fixed gain stages 106, 108 and a variable gain stage 110. The gain of the variable gain stage 110, which is commonly referred to as a TIA, is set according to the value (resistance) of a variable resistor 112. In a particular embodiment, the variable resistor is a resistor network having switchable resistor values. In a particular embodiment, the optical receiver is integrated with an optical transmitter in an optical transceiver. In a particular embodiment, the optical transceiver is an IC.

V_{BIAS} is a reference voltage of the TIA that sets the output voltage and the inverting input of the TIA biasing point (operating point). V_{BIAS} also determines the reverse bias voltage of the photo-detector as the reverse bias voltage is equal to V_{DD} minus V_{BIAS}. The reverse bias voltage of the photodiode determines the junction capacitance of the diode; therefore, the speed of the photodiode is also a function of the reverse bias voltage. In some designs, V_{BIAS} is a bandgap voltage (“V_{BG}”) of a bandgap voltage reference source or a resistively divided bandgap voltage reference source. Setting V_{BIAS} depends on the junction capacitance of the photodiode. It is generally desirable to select V_{BIAS} to achieve the maximum bit rate of the receiver.

A photodetector 114, such as a photodiode, converts light energy, represented by an arrow 116, to an electrical signal V_{Sin}, which is provided to the negative input of the variable gain stage 110. The gain of the variable gain stage 110 is set by a step-wise control value V_{Cont} from the digital AGC circuit 102. The control value determines (i.e. sets) the resistance of the variable resistor 112. In other words, the gain of the variable gain stage 104 is set according to the digital control value.

The output V_{SOUT} of the gain section 104 is coupled to detector circuits 118, 120. A first detector circuit 118 is a peak detector, and a second detector 120 is a bottom detector circuit, which is also known as a valley detector or a floor detector.

The detector circuits rectify V_{SOUT} and obtain the peak (i.e. pulse or data high state) and bottom (i.e. low data state) of V_{SOUT}. The difference between the peak and bottom values is the signal amplitude. V_{SOUT} is coupled to a comparator 107, which in a particular embodiment is a hysteresis comparator. The comparator 107 compares V_{SOUT} against a threshold voltage V_{TH} and produces an output coupled to a driver 109. The driver insures that signal at the output is appropriate for driving downstream circuitry. V_{SOUT} is also coupled to a clock generation circuit 122. The clock generation circuit 122 includes an optional high-pass filter, shown as a capacitor 124 and resistor 126, and a comparator 128, to generate a clock signal clk synchronized with the input data.

In a particular embodiment, the comparator 128 has a small amount of hysteresis to prevent switching due to noise. This hysteresis also sets the minimum input strength required for clock generator operation, and is typically set above the noise floor. If a long series (run) of zeros (low data condition) or ones (high data condition) is received, it is not necessary for the digital AGC to operate because the gain setting will not likely have to change within the series.

The clock signal is used to synchronize gain switching through further generation of other clock signals clk1, clk2. One of the clock signals clk1 is used to control a switch 130 in the bottom detector 120. The switch 130 resets the bottom detector 120 on clk 1 after the clock signal clk latches into the results of a reference and comparator section 132. The level of the bottom signal for different data bit signals might be different from each other, and resetting the bottom detector 120 by operation of the switch 130 facilitates correct detection of successive data bottoms.

The reference and comparator section 132 receives an input V_{PEAK} from the peak detector circuit 120 to set the references Ref₀ . . . Ref_{N} or the threshold voltages of each comparator C₀ . . . C_{M} in the reference and comparator section 132 so that a more accurate reference Ref₀ . . . Ref_{N} can be set from V_{PEAK}. When there is no input signal from the photo detector, and if we ignore the offset voltages in the circuits, V_{PEAK} will have the same operating point, namely the DC operating point, as the V_{BIAS} voltage. Photodetector circuits often have circuitry to cancel or filter out the DC component of the detected light, which arises from ambient light, such as sunlight or room lighting. However, cancellation of the DC component is not perfect; therefore, there is usually some offset on the V_{SOUT} compared to compared with the V_{BIAS}.

The peak detector circuit 118 obtains the peak voltage of V_{SOUT}. Deriving the reference for Ref₀ . . . Ref_{N} from V_{PEAK}, rather than from V_{BIAS}, provides a more accurate reference voltage. A simple resistor divider method for obtaining the various reference voltages Ref₀ . . . Ref_{N} is shown in FIG. 1A. The reference voltages Ref_{N}, . . . , Ref₁, Ref₀ are fractions of V_{PEAK}. For example, Ref₀=R₀/(R₀+R₁+. . . +R_{N})×V_{PEAK}. Alternative embodiments use other methods to generate a series of reference voltages from V_{PEAK}. Another voltage reference circuit 142 is shown in FIG. 1B. V_{PEAK} is buffered by a buffer 144 and provided to a resistive divider R_{N}, . . . , R₁, R₀. A constant current source 146 is provided in series with the resistive divider and produces a constant current I_{const} through the resistive divider. I_{const} is derived from a band gap voltage V_{BG}, where I_{const}=V_{BG}/R_{BG}.

The reference voltages Ref₀, . . . Ref_{N} are functions of the resistance times the constant current, I_{const}. Using a constant current source 146 with a band gap voltage reference produces I_{const} that is relatively independent of temperature and supply voltage.

The reference voltages are connected to the inverting inputs of their respecitive comparators. The comparators are configured to produce a particular logic pattern to indicate whether the signal level out of the variable gain stage 110 needs to be adjusted down or up to maintain the peak and bottom values in a desired range. A latch 134 is connected to the outputs of the reference and comparator section 132. The clock signal clk is used to latch bit patterns in the latch before the bottom detector 120 is reset.

The output of the latch 134 is connected to a sequential logic cirucut 136, which in a particular embodiment is a counter and in another embodiment is a four-bit shift register. The digital output value V_{count} increments or decrements according to the bit pattern output by the latch 134. The sequential logic circuit 136 is synchronized by clk2, which in turn switches the gain of the variable gain stage 110 by changing the value of the variable feedback resistor 112. If there is no signal present, or the signal V_{Sin} is low, the gain is decreased to minimize switching noise at the output V_{SOUT} of the gain section 104. It is necessary to reset the counter.

There are two conditions that may occur. One condition is that the V_{SIN} signal gradually decreases and the other condition is that the V_{SIN} signal abruptly changes to a very low value or to zero. When the gain of the gain section 104 is in a setting other than the maximum gain setting, and if V_{SIN} gradually decreases, the digital ACG will increase the gain to the next higher gain setting. If V_{SOUT} continues to decrease, the gain will continue to be switched to the next higher gain setting until the maximum gain setting is reached. Operation of the digital AGC circuit is possible as long as the clock generation circuit 122 produces a clock signal clk synchronized with the input data. The clock signal is generated from the V_{SOUT}. If no clock signal clk is produced, the digital AGC circuit takes no action.

A clock signal clk is not generated if V_{SIN} abruptly changes (i.e. like a step) function to a very low value or to zero. In such case, V_{SOUT} will become very small or zero such that it becomes insufficient to produce the clock signal clk. A time-out reset (“TOR”) circuit 180 accepts the inputs from V_{COUNT} and clk1 to detect the start of a time-out delay. The time-out delay will only start when the gain setting is not at the maximum from V_{COUNT} signals and there is no clock clk1 from the clock generation circuit 122. The time-out delay is re-triggerable by the clk1 signal.

At the end of the time out delay, a high signal will be generated by the TOR circuit 180. The high signal from the TOR circuit 180 is coupled into an input of an OR gate 140. The other input of the OR gate 140 is connected to the power on reset (“POR”) signal. A high output of the OR gate will reset the counter 136 to set the gain section 104 to the maximum gain.

The sequential logic circuit 136 is a shift register or other logic circuit that produces a digital output value that a variable gain stage can use to set its gain. In other words, the type of counter circuit selected for a particular application is one that provides a digital output that the selected variable gain stage can decode.

FIG. 1C shows a portion of an integrated digital AGC circuit 150 according to an embodiment of the invention. The digital AGC circuit is fabricated as part of an IC on a silicon chip, for example. In a particular embodiment, the digital AGC circuit is part of an integrated IR transceiver chip. The V_{SOUT} signal from a gain stage having a variable gain amplifier (see, e.g., FIG. 1A, ref. nums. 104, 110) is buffered by an operational amplifier (“OPAMP) 154. The output V_{buf—sout} of the OPAMP 154 is fed into three blocks, a peak detector circuit 156, a bottom detector circuit 158, and a clock generation circuit 160. The peak detector 156 includes a holding capacitor 157. A high-pass filter is used to filter out the DC component of V_{buf—Sout} and creates a pulse at the output of a comparator 162. In a particular embodiment, V_{BIAS} is generated from a bandgap voltage. In a particular embodiment, the high-pass filter has a cut-off frequency of about 150 KHz. This frequency provides good operation of the digital AGC circuit for mid infrared (“MIR”) and fast infrared (“FIR”) data reception. In a particular IR transceiver, digital AGC is not used in slow infrared (“SIR”) mode because a one-shot circuit is available for use in SIR mode. The one-shot circuit removes the effects of pulse widening when the input irradiance increases. The one-shot circuit does not require the digital AGC. Alternatively, a digital AGC is used in SIR mode.

The peak voltage V_{PEAK} from the detector circuit 156 and the bottom voltage V_{bot} from the detector circuit 158 are coupled to a reference and comparator section 166. The peak voltage V_{PEAK} is coupled to a resistive voltage divider 168 that produces a high threshold voltage V_{TH} and a low threshold voltage V_{TL1}, which are compared to V_{BOT} using comparators 170, 172. The outputs of the comparators 170, 172 are coupled to a latch circuit 174 that is coupled to a counter 176. The counter generates a series of outputs Unity, SW, MID, MIN, and is reset on power-up.

The clock signal clk generated by the clock generation circuit 160 is coupled to another clock generation circuit 164, which generates other clock signals clk1, clk2 that follow the clock signal clk. The falling edge of the clock signal clk is used to latch the outputs UPGAIN, DOWNGAIN of the comparators 170, 172 in the latch 174. A band-gap reference voltage V_{BIAS} is coupled to the output of the bottom detector circuit 158 through a switch 178 controlled by clk1. Clk 1 is used to reset to V_{BIAS} in anticipation of the next bottom detection after latching the outputs UPGAIN, DOWNGAIN of the reference and comparator section 166 into the latch 174.

The counter outputs Unity, SW, MID and MIN are connected to the time-out reset (“TOR”) circuit 180. The TOR circuit 180 only activates when the signal received from the photo detector is too small to generate the clock signal clk from the clock generation circuit 160 and the gain is not maximum. This condition indicates that data transmission has ended, such as from ending data transfer or from removing the receiver from the IR link. The TOR circuit 180 resets the gain of the AGC circuit to maximum, so as to be ready for the next data transmission. The gain of the AGC circuit is also set to maximum gain if a POR signal is received at OR gate 140.

Unity, SW, MID and MIN is coupled to a combination logic circuit 182. The combination logic 184 produces a high signal at output 184 only when the Unity, SW, MID and MIN signals indicate the gain is at the maximum (e.g. Unity, Sw, MID, and MIN are all zero), at any other gain condition (i.e. any other counter output pattern), the output 184 will be low. The output 184 controls a switch 186. A high at output 184 (“VON”) turns on the switch 186, which in a particular embodiment is an n-channel MOSFET, and pulls the capacitor 192 low. If the gain of the AGC circuit is not at maximum, V_{ON} is low and the switch 186 is off.

Gain control now falls on the second clock signal clk1. The second clock signal clk1 is generated from the first clock signal clk, which is generated (derived) from the photo detector signal V_{SIN}. The clk1 signal is connected another switch 188. A high clk1 signal turns on the switch 188 and pulls the capacitor 192 low. As long as V_{SIN} is strong enough to generate the clock signals clk, clk1, the capacitor 192 will be reset at each pulse or retriggered at each pulse. When the input V_{SOUT} is too small or zero, no clock signal clk is generated. There will be also no clk1 signal because clk1 is derived from the clock signal clk. When the gain setting is not at the maximum, the switches 186,188 are off. The capacitor 192 starts to charge-up from a current source 190. As the voltage across the capacitor 192 is less than V_{BIAS}, the TOR output of the comparator 196 is low.

The TOR delay is designed so that the delay is longer than the time between the end of one data frame (package) and beginning of the next data frame. This prevents resetting the gain between two adjacent frames. In doing so, it prevents unnecessary gain switching from occurring in the subsequent frame. In an environment where various IR systems are operating, it is desirable that a higher speed system be able to operate in the presence of (i.e. coexist with) a slower speed system. In IrDA systems (see, e.g., section 5.2 of the IrDA Physical Layer Specification, Version 1.4), once the speed connection has been established between the transmitter and the receiver of the higher speed system, the higher speed system must emit a serial infrared interaction pulse (“SIP”) at least once every 500 ms as long as the connection lasts to quiet slower systems that might otherwise interfere with the link. The TOR reset time for use in IrDA systems is preferably at least 500 ms.

As the voltage of the capacitor 192 charges up, the voltage will exceed V_{BIAS}. When this happens, the TOR output changes to high from low. A high at TOR will cause a high at RST of the counter 176 and will reset the counter 176. An OR gate 140 is used so that the counter 176 resets on either POR or TOR. The time out delay is determined by V_{BIAS}, the constant current “I” from the current source 190 and the capacitance “C” of capacitor 192. The time out delay is equal to (C/I)×V_{BIAS}.

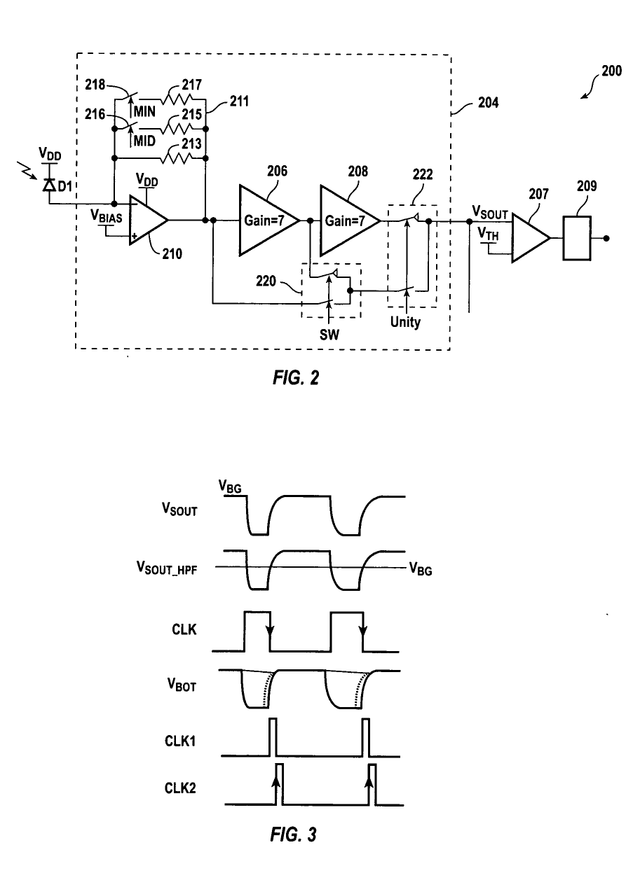

FIG. 2 shows a portion of a digital optical receiver 200 according to an embodiment of the invention. A gain section 204 has a variable gain stage 210 and two fixed gain stages 206, 208. Each fixed gain stage 206, 208 provides a gain step of 7, so that there is a combined gain of 49 between the output of the variable gain stage 210 and V_{SOUT}.

Referring to FIG. 1C, note that the different between the peak and the bottom voltages is the voltage amplitude of the V_{SOUT}. V_{BOT} is compared against the two references, 0.1 V_{PEAK} (V_{TL}) and 0.9 V_{PEAK} (V_{TH}). The maximum allowable swing of V_{SOUT}, if we ignore the saturation of the outputs, is V_{PEAK}. When V_{SOUT} has an amplitude of 0.9 of V_{PEAK} or more (meaning the V_{TL} reference comparator 172 shown in FIG. 1C will be activated), the gain will switch to lower gain by bypassing one of the fixed gain stages reducing the combined gain 7 times lower than the initial combined gain. When this switching occurs, the new amplitude at the V_{SOUT} will be 0.9/7 V_{PEAK}, in other words, 0.128 V_{PEAK}. This new V_{SOUT} is higher than 0.1 V_{PEAK}, which means that the V_{TH} reference comparator 170 of FIG. 1C will not be activated.

Similarly, when the V_{SOUT} signal falls to an amplitude of 0.1 of V_{PEAK} or less, the V_{TH} reference comparator 170 of FIG. 1C will be activated. An increase in gain is desired, so a fixed gain stage is switched in, adding a gain of 7 times higher than the initial gain. After switching in the gain stage, the new amplitude at V_{SOUT} will be 0.1×7 V_{PEAK}, or 0.7 V_{PEAK}, which is less than 0.9 V_{PEAK}. In this condition, the V_{TL} reference comparator 172 of FIG. 1C will not be activated. Thus, hysteresis is provided, which prevents noise or signal jitter from initiating gain switching. Setting V_{TL} to 0.1 V_{PEAK} accounts for the lower saturation of the output stage at V_{SOUT} compared to V_{PEAK}.

The gain of the variable gain stage 210 is determined by the amount of feedback provided by a switched resistor network 211. In alternative embodiments, the fixed gain stages have different amounts of gain.

The switched resistor network 211 has a first resistor 213 that is not switched, a second resistor 215 that is selectively switched into or out of the feedback path, and a third resistor 217 that is also selectively switched into or out of the feedback path. In a particular embodiment, the first resistor 213 has a resistance of about 28 Kohms, the second resistor 215 has a resistance of about 4.67 Kohms, and the third resistor 217 has a resistance of about 0.67 Kohm. When the second and third resistors are switched out of the feedback path, the feedback resistance is the resistance of the first resistor, 28 Kohms. When one of the second and third resistors is switched into the feedback path, the feedback resistance is the parallel combination of the two resistors in the feedback path. When both the second and third resistors are switched into the feedback path, the feedback resistance is the parallel combination of all three resistors. Thus, four different feedback resistances, and hence four different gain values from the variable gain stage 210, are possible. In some embodiments, not all possible gain values are used, for example, only three of the four possible gain values are used. In alternative embodiments, only two resistors are provided, in others, more than three resistors are provided. In yet other embodiments, the feedback path includes a variable resistor. The above resistance values are merely exemplary. In another embodiment, the first resistor is also switchable.

Referring to FIGS. 1B and 2, the MID and MIN outputs of the counter 176 control the switches 216, 218 in the resistor network 211. The latch 174 operates according to V_{bot} as shown in Table 1:

TABLE 1

| Condition | UPGAIN | DOWNGAIN |
|---|---|---|
| V_{bot} > Vₜₕ | 1 | 0 |
| Vₜₗ < V_{bot} < Vₜₕ | 0 | 0 |
| V_{bot} < Vₜₗ | 0 | 1 |

The latch outputs UPGAIN, DOWNGAIN are coupled to the counter 176. When clk2 goes high, the outputs of the latch 174 will change the output of the counter 176 if there is a need to increase or decrease the value of the counter. In a particular embodiment, the counter is a four-bit shift register, but other types of counters are used in alternative embodiments. Power-on resets the counter value to an initial condition. The counter outputs corresponding to various are shown in Table 2:

TABLE 2

| State | Unity | Sw | MID | MIN | V_{ON} | Trans-Impedance Gain |
|---|---|---|---|---|---|---|
| 1 | 0 | 0 | 0 | 0 | 1 | 1372K (max.) |
| 2 | 1 | 0 | 0 | 0 | 0 | 196K |
| 3 | 1 | 1 | 0 | 0 | 0 | 28K |
| 4 | 1 | 1 | 1 | 0 | 0 | 4K |
| 5 | 1 | 1 | 1 | 1 | 0 | 0.57K (min.) |

The Sw and Unity outputs of the counter 176 operate switches 220, 222. Actuating switch 222 (Unity=1) reduces the overall gain of the gain section 204 by bypassing the fixed gain stage 208, and actuating switch 220 (Sw=1) further reduces the overall gain of the gain section by bypassing the fixed gain stage 206.

Similarly, when MID=1 the second resistor 215 in the resistor network 211 is switched into the feedback path, reducing the feedback resistance, and hence increasing the feedback and reducing the gain of the variable gain stage 210, to the parallel combination of the first resistor 213 and the second resistor 215. When MIN=1 the third resistor is switched into the feedback path, further lowering the feedback resistance and reducing the gain. In an alternate embodiment, the second resistor has a lower resistance than the third resistor, or the same resistance as the third resistor.

Referring to Table 2 in light of FIG. 2, the maximum gain of the gain section 204 occurs when both fixed gain stages are contributing to the overall gain, and minimum feedback to the variable gain stage provides the maximum gain from the variable gain stage. Lesser gain is achieved by progressively switching out one fixed gain stage, then another fixed gain stage, and then by increasing the feedback to the variable gain stage in two steps. Similarly, overall gain is increased in the opposite count direction. Thus, overall gain of the gain section 204 changes as the count value changes. The gain section 204 can switch from the maximum gain state to the minimum gain state with only four data pulses (state 1 being set on power-up). The gain values shown in Table 2 are merely exemplary.

In an IrDA system, a preamble of pulses is sent before data is transmitted. The digital optical receiver 200 is able to achieve the final switching condition (i.e. gain state) within the preamble of the optical signal, thus preventing data loss. Alternative counters and/or gain sections provide more or fewer states, and/or different gain sequences. For example, in an alternative embodiment the feedback resistance is decreased before a fixed gain stage is switched out.

FIG. 3 shows plots of input and output signals of a digital AGC according to an embodiment. In a particular embodiment, the digital AGC is substantially as shown in FIG. 1C, ref. num. 160 and the plots will be discussed with reference FIG. 1B. The peak detector 156 and bottom detector 158 are used to sample the peak and bottom of each data pulse signal. The resistor divider 168 in the reference and comparator section 166, in combination with the holding capacitor 157, sets the reference voltages V_{TH}, V_{TL} with a selected RC time constant. In a particular embodiment, V_{TH} is set to 0.9 of V_{PEAK} and V_{TL} is set to 0.1 of V_{PEAK} to ensure that, when the gain is switched to the next level (i.e. the next feedback value, see FIG. 2), the bottom of the next data pulse V_{SOUT} is between V_{TH} and V_{TL}. When the AGC gain is at the maximum, V_{SOUT} can be less than 0.1 V_{PEAK}, and when the AGC gain is at the minimum, V_{SOUT} can be greater than 0.9V_{PEAK}.

In a particular embodiment, a gain section (see, e.g., FIG. 2, ref. num. 204) has fixed gain stages (FIG. 2, ref. nums. 206, 208) following a variable gain stage (FIG. 2, ref. num. 210). Referring to FIG. 1C, the V_{SOUT} signal is buffered by OPAMP 154 to produce V_{BUF—SOUT}. V_{BUF—SOUT} is passed through a HPF filter that removes the DC component to produce V_{SOUT-HPF}, which has V_{BIAS} as the average voltage. The V_{SOUT—HPF} is coupled to the comparator 162, which produces the clock signal clk. The clock signal clk is coupled to another clock generation circuit 164. A second clock signal clk1 is generated from the falling edge of clock signal clk, and a third clock signal clk2 is generated from the falling edge of the second clock signal clk1.

The rising edge of the clock signal clk latches the control signals UPGAIN and DOWNGAIN into the latch circuit 174, which uses two D flip-flops in a particular embodiment. The high level of the second clock signal clk1 is used to turn on (close) the switch 178 and reset V_{BOT} output to V_{BIAS}, which is the DC voltage when there is no input photo signal. The counter 176 changes states on the rising edge of the signal clk2, which is generated by the falling edge of the second clock signal clk1.

The peak detector circuit 156 will produce V_{PEAK}, which is the peak voltage of the V_{BUF—SOUT}. The bottom detector circuit 158 will detect the bottom of the V_{BUF—SOUT} and hold it long enough for the outputs of the comparators 170 172 to stablize and latch outputs UPGAIN and DOWNGAIN in the latch 174 on the falling edge of the clk signal. The high of the second clock signal clk1 will reset V_{BOT} for the next cycle.

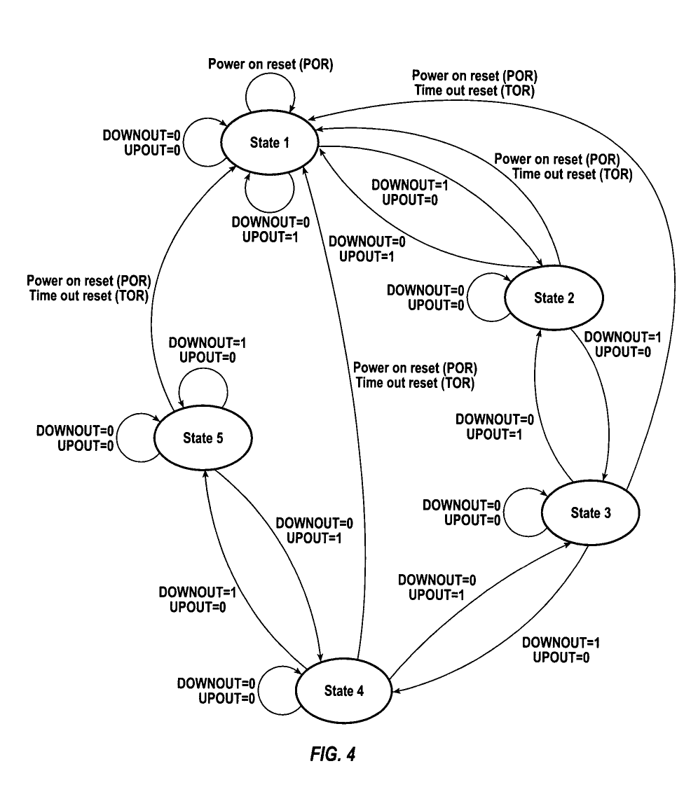

FIG. 4 is a state diagram 400 according to an embodiment of the invention using a four-bit shift register as a counter. The logic levels of the each state are shown in Table 2. Upon power up, there will be a reset signal that initializes the counter to the initial state (State 1). In State 1, the AGC circuit has the highest gain. Referring to FIG. 1C, the counter 176 will move from it present state to the next state or to the previous state, depending on the control signals UPOUT and DOWNOUT, respectively, or remains in its present state if neither control signal is generated (e.g. when UPOUT=DOWNOUT=0). When DOWNOUT equals zero and UPOUT equals 1, the counter will move back the pervious state unless the counter is already in State 1 (maximum gain), in which case it will remain in its present state. In other words, when UPOUT equals one, the gain state increments.

When DOWNOUT equals one and UPOUT equals zero, the counter will decrement to the next state unless the counter is already in State 5. In other words, when DOWNOUT equals 1, the gain state decrements. In this embodiment, it is invalid for both DOWNOUT and UPOUT are equal to one, as the comparators will not generate because it is impossible that the peak voltage is lower than the V_{TL} and at the same time, higher than V_{TH}. Alternative states and logic values are used in other embodiments. The counter 176 is reset to an initial state, State 1, upon power up reset (POR) or time out reset (TOR).

While the preferred embodiments of the present invention have been illustrated in detail, it should be apparent that modifications and adaptations to these embodiments might occur to one skilled in the art without departing from the scope of the present invention as set forth in the following claims.

What is claimed is:

1. An optical receiver comprising:
a photodetector;
a gain section including a variable gain stage providing an output voltage signal; and
a digital automatic gain control circuit coupled to the output voltage signal and providing a digital output value to at least the variable gain stage, a gain of the variable gain stage being set according to the digital output value.

2. The optical receiver of claim 1 wherein the gain section further includes a fixed gain stage.

3. The optical receiver of claim 2 wherein the fixed gain stage is selectively bypassed according to a second digital output value from the digital automatic gain controller.

4. The optical receiver of claim 3 wherein the gain section further comprises a switch controlled according to the second digital output value, the switch coupling an output of the fixed gain stage to an output of the gain section in a first state and coupling an input of the fixed gain stage to the output of the gain section in a second state.

5. The optical receiver of claim 1 wherein the variable gain stage includes a variable resistor coupling an output of the variable gain stage to an input of the variable gain stage.

6. The optical receiver of claim 5 wherein the variable resistor comprises a switched resistor network.

7. The optical receiver of claim 6 wherein the switched resistor network includes a fixed resistor and a plurality of selectively switchable resistors.

8. The optical receiver of claim 1 wherein the digital automatic gain control circuit includes a peak detector circuit configured to detect a peak value of the output voltage signal and to provide a peak detector output, and a bottom detector circuit configured to detect a bottom value of the output voltage signal and to provide a bottom detector output.

9. The optical receiver of claim 8 wherein the digital automatic gain control circuit further includes
a reference and comparator section having a first comparator comparing the bottom detector output to a first reference voltage and a second comparator comparing the bottom detector output to a second reference voltage, the first reference voltage and the second reference voltage each being set according to the peak detector output.

10. The optical receiver of claim 9 wherein the digital automatic gain control circuit further comprises
a latch circuit coupled to the first comparator and to the second comparator; and
a counter coupled to the latch circuit and providing a plurality of digital output values.

11. The optical receiver of claim 10 wherein the counter comprises a four-bit shift register.

12. The optical receiver of claim 10 further comprising
a switched resistor network having a first switchable resistor and a second switchable resistor in a feedback path of the variable gain stage;
a first fixed gain stage; and
a second fixed gain stage, wherein a first of the plurality of digital output values switches the first switchable resistor into the feedback path, a second of the plurality of digital output values switches a second switchable resistor into the feedback path, a third of the plurality of the digital output values bypasses the first fixed gain stage, and a fourth of the plurality of the digital output values bypasses the second fixed gain stage.

13. The optical receiver of claim 10 further comprising a clock generation circuit generating a clock signal from the output voltage signal.

14. The optical receiver of claim 13 wherein the digital automatic gain control circuit further comprises a second clock generation circuit generating a second clock signal and a third clock signal from the clock signal, the bottom detector circuit being reset according to the second clock signal and the counter being clocked according to the third clock.

15. The optical receiver of claim 1 wherein the optical receiver is integrated in an infrared transceiver.

16. The optical receiver of claim 15 wherein the infrared transceiver is integrated on a silicon chip.

17. The optical receiver of claim 1 further comprising a time out reset circuit configured to set gain of the gain section to maximum gain after a selected period of time.

18. The optical receiver of claim 17 wherein the gain section is set to maximum gain after one of a time out reset signal and a power on reset signal.

19. The optical receiver of claim 10 further comprising a time out reset circuit including logic coupled to the plurality of digital output values.

20. The optical receiver of claim 19 wherein the time out reset circuit includes
a capacitor having a first terminal and a second terminal connected to a voltage reference,
a first switch disposed between the first terminal of the capacitor and the voltage reference controlled by an output of the logic,
a second switch disposed between the first terminal of the capacitor and the voltage reference controlled by a clock signal, and
a current supply configured to provide current to the first terminal.
